(19) United States
(12) Patent Application Publication
(10) Pub. No.: US 2025/0354925 A1
(43) Pub. Date: Nov. 20, 2025

(54) IMAGING APPARATUS AND CONTROL METHOD OF IMAGING APPARATUS

(71) Applicant: CANON KABUSHIKI KAISHA, Tokyo (JP)

(72) Inventor: SHIGEYUKI KOBAYASHI, Kanagawa (JP)

(21) Appl. No.: 19/199,451

(22) Filed: May 6, 2025

(30) Foreign Application Priority Data
May 16, 2024 (JP) 2024-080456

(51) Int. Cl. G01N 21/3581

(52) U.S. Cl. CPC G01N 21/3581; G01N 2201/0638

(57) ABSTRACT

An imaging apparatus includes a light emitting element that irradiates a subject with a terahertz wave, an imaging element that detects a reflected terahertz wave, an image forming optical system that includes a focus lens and forms an image of a terahertz wave on the imaging element, a support member that supports the light emitting element; an orientation changing unit that changes an orientation of the support member, a focus changing unit that changes the position of the focus lens; an input unit to which set distance information is input, and an execution unit that executes the change of the orientation of the support member and the change of the position of the focus lens based on the set distance information.

### BACKGROUND OF THE INVENTION

### Field of the Invention

The present invention relates to an imaging apparatus using terahertz waves.

### Description of the Related Art

In recent years, preventing crimes involving concealed dangerous objects at airports and other locations has become a challenge, and a technology for detecting dangerous objects has been required. As one of these inspection techniques, an imaging apparatus using a terahertz wave is known. In this context, terahertz waves are generally defined as electromagnetic waves having a frequency equal to or higher than 30 GHz and equal to or lower than 30 THz and have transparency to clothes and the like because of the long wavelengths thereof. In addition to a large gate-type imaging apparatus, which is designed to be fixed, a handheld-type imaging apparatus is also desired as a terahertz imaging apparatus for the purpose of noncontact body checks in place of conventional body checks.

Japanese Patent Application Laid-Open No. 2021-081443 discloses a configuration for the purpose of inspecting concealed objects such as body checks in public places, wherein terahertz waves are emitted from an illumination unit toward a subject and terahertz waves reflected by the subject are acquired by an imaging unit. When it is attempted to configure a handheld-type terahertz imaging apparatus with reference to Japanese Patent Application Laid-Open No. 2021-81443, the following drawback occurs.

Since terahertz waves have a relatively longer wavelength than the surface irregularities of the subject, terahertz waves irradiated onto the subject surface do not scatter but undergo specular reflection. Accordingly, it is necessary to set the angle of illumination so that the terahertz waves specularly reflected by the subject enter the camera unit. Since the handheld type allows the user to appropriately change the imaging range, the distance between the subject and the imaging apparatus is not necessarily constant. For example, it is conceivable to perform image capturing of the subject from a far distance to confirm the entire subject, and then bring the imaging apparatus closer to the subject to perform image capturing of a part of the subject with magnification. Therefore, it is necessary to readjust the angle of the illumination each time the distance between the subject and the imaging apparatus changes.

In addition, when the distance between the subject and the imaging apparatus changes, it is also necessary to readjust the focus. Accordingly, the user needs to perform both adjustment of the illumination angle and focusing, and it takes time until an image can be captured as intended. More specifically, although the user must first adjust the illumination angle so that the illumination hits the subject, the subject is not visible on the camera until the illumination hits the subject correctly, and therefore the focus cannot be set in advance. That is, even if the illumination angle is adjusted, a blurred subject having unfocused focusing is displayed. Since it is difficult to determine whether the intended range is being captured when the subject is blurred, it becomes necessary to fine-adjust the illumination angle again after focusing. Accordingly, it takes time until image capturing can be performed as intended by the user.

### SUMMARY OF THE INVENTION

An imaging apparatus comprising: a light emitting element configured to irradiate a subject with a terahertz wave; an imaging element configured to detect a terahertz wave reflected by a subject; an image forming optical system configured to include a focus lens and form an image of a terahertz wave reflected by a subject on the imaging element; a support member that supports the light emitting element; a housing that supports the support member; at least one processor or circuit configured to function as: an orientation changing unit configured to change an orientation of the support member with respect to the housing; a focus changing unit configured to be provided in the image forming optical system and change the position of the focus lens; an input unit configured to receive set distance information that is a set value of a distance from the imaging element to a subject; and an execution unit configured to execute the change of an orientation of the support member by the orientation changing unit and the change of a position of the focus lens by the focus changing unit, based on the set distance information.

Further features of the present invention will become apparent from the following description of exemplary embodiments with reference to the attached drawings.

### BRIEF DESCRIPTION OF THE DRAWINGS

FIG. 1 is a diagram illustrating functional blocks of an imaging apparatus according to a first embodiment.

FIG. 2 is a diagram illustrating a hardware configuration of the imaging apparatus according to the first embodiment.

FIG. 3 is a diagram illustrating an external appearance of the imaging apparatus according to the first embodiment.

FIG. 4 is an explanatory diagram showing an internal configuration of the imaging apparatus of the first embodiment as viewed from above.

FIG. 5A and FIG. 5B are diagrams explaining a rotation unit of a second support member according to the first embodiment.

FIG. 6 is a diagram explaining a positional relation between a light emitting element, an imaging element, and a subject according to the first embodiment.

FIG. 7 is a diagram explaining a positional relation between a light emitting element, an imaging element, and a subject according to the first embodiment.

FIG. 8 is a diagram explaining a positional relation between a light emitting element, an imaging element, and a subject according to the first embodiment.

FIG. 9 is a diagram illustrating an operation flow of the imaging apparatus according to the first embodiment.

FIG. 10 is a diagram explaining an example of a display unit of the imaging apparatus according to the first embodiment.

FIG. 11 is an explanatory diagram showing an internal configuration of an imaging apparatus according to a second embodiment as viewed from above.

FIG. 12A and FIG. 12B are diagrams explaining the rotation unit of the first support member and the second support member according to the second embodiment.

FIG. 13 is a diagram illustrating functional blocks according to a third embodiment.

FIG. 14 is an illustration of an internal configuration of the imaging apparatus according to the third embodiment as viewed from above.

FIG. 15 is a diagram explaining a rotation unit of the support member according to the third embodiment.

FIG. 16A and FIG. 16B are diagrams explaining the positional relation between the light emitting element and the imaging element before and after movement of a subject according to the third embodiment.

FIG. 17 is a diagram explaining a positional relation between the light emitting element and the imaging element before and after the movement of the subject according to the third embodiment.

FIG. 18A and FIG. 18B are diagrams explaining the positional relation between the light emitting element and the imaging element before and after the movement of the subject according to the third embodiment.

FIG. 19 is a diagram explaining a positional relation between the light emitting element and the imaging element before and after the movement of the subject according to the third embodiment.

FIG. 20 is a diagram illustrating functional blocks of the imaging apparatus according to the fourth embodiment.

FIG. 21 is a diagram illustrating a hardware configuration of the imaging apparatus according to the fourth embodiment.

FIG. 22 is a diagram illustrating an external appearance of an imaging apparatus according to the fourth embodiment.

FIG. 23 is an explanatory diagram showing an internal configuration of the imaging apparatus according to the fourth embodiment as viewed from above.

FIG. 24 is a diagram explaining a positional relation between a light emitting element, an imaging element, a subject, and a ranging sensor in the fourth embodiment.

FIG. 25A and FIG. 25B are diagrams illustrating an appearance of an imaging apparatus according to the fifth embodiment.

### DESCRIPTION OF THE EMBODIMENTS

Hereinafter, embodiments for carrying out the present invention will be explained in detail. Note that the embodiments to be explained below are examples for carrying out the present invention and should be modified or adjusted as appropriate depending on the configuration of an apparatus to which the present invention is applied and various conditions, and the present invention is not limited to the following embodiments. Additionally, in all the drawings, components having the same function are denoted by the same reference numerals, and the repetitive description thereof will be omitted.

### First Embodiment

### (Functional Configuration)

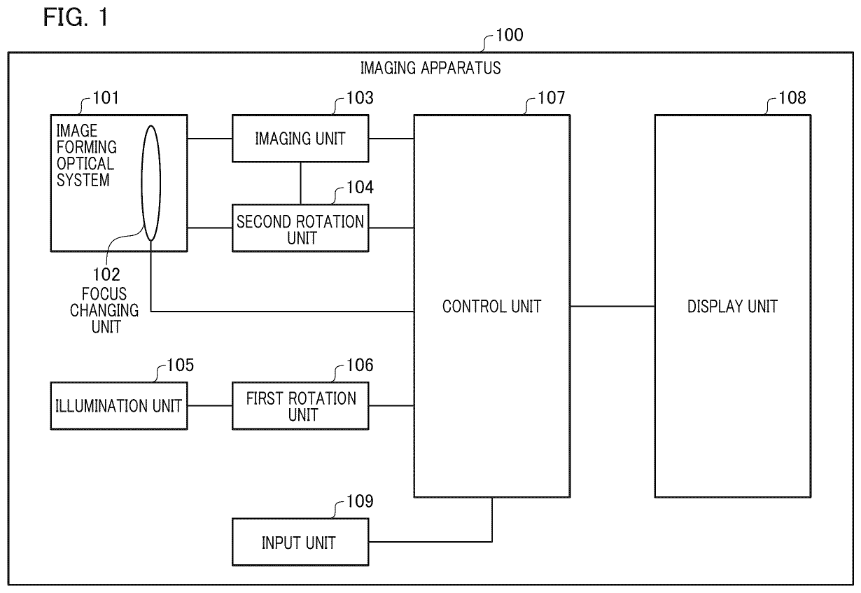

FIG. 1 is functional blocks diagram of an imaging apparatus 100 in a first embodiment. The imaging apparatus 100 includes an image forming optical system 101 provided with a focus changing unit 102, an imaging unit 103 having sensitivity to terahertz waves, and an illumination unit 105 that irradiates terahertz waves onto a subject.

Additionally, the imaging apparatus 100 includes a first rotation unit 106 that serves as a first orientation changing unit that changes an angle of the illumination unit 105 with respect to the housing, a second rotation unit 104 that serves as a second orientation changing unit that changes an angle of the imaging unit 103 with respect to the housing, and a control unit 107 that serves as an executing unit.

Furthermore, the imaging apparatus 100 includes an input unit 109 that serves as an input unit capable of inputting setting distance information when the user changes the angles of the illumination unit 105 and the imaging unit 103 with respect to the housing, and a display unit 108 that serves as a display unit for the user to confirm a captured image.

The imaging optical system 101 forms a subject image on the imaging unit 103 by the focus changing unit 102. The imaging unit 103 captures a subject image, converts the subject image into an image signal, and transfers the image signal to the control unit 107. The control unit 107 processes the received image signal by converting the image signal into image data, and causes the display unit 108 to display the image data as a captured image.

Additionally, the control unit 107 receives setting distance information from the input unit 109 by an operation of the user, and instructs the second rotation unit 104 and the first rotation unit 106 to change angles according to the setting distance information. The second rotation unit 104 and the first rotation unit 106 perform driving so that the imaging unit 103 and the illumination unit 105 are set at instructed angles.

Additionally, the control unit 107 changes the position of a focus lens 406 through the focus changing unit 102 according to angles of the imaging unit 103 and the illumination unit 105.

In FIG. 1, although the control unit 107 and the display unit 108 are built in the imaging apparatus 100, data transfer from the imaging apparatus 100 may be performed by using a cable or wireless communication provided outside the imaging apparatus 100. Additionally, among the functional blocks shown in FIG. 1, a single functional block may be configured by a plurality of functional blocks, or a plurality of functional blocks may be combined into a single functional block.

### (Hardware Configuration)

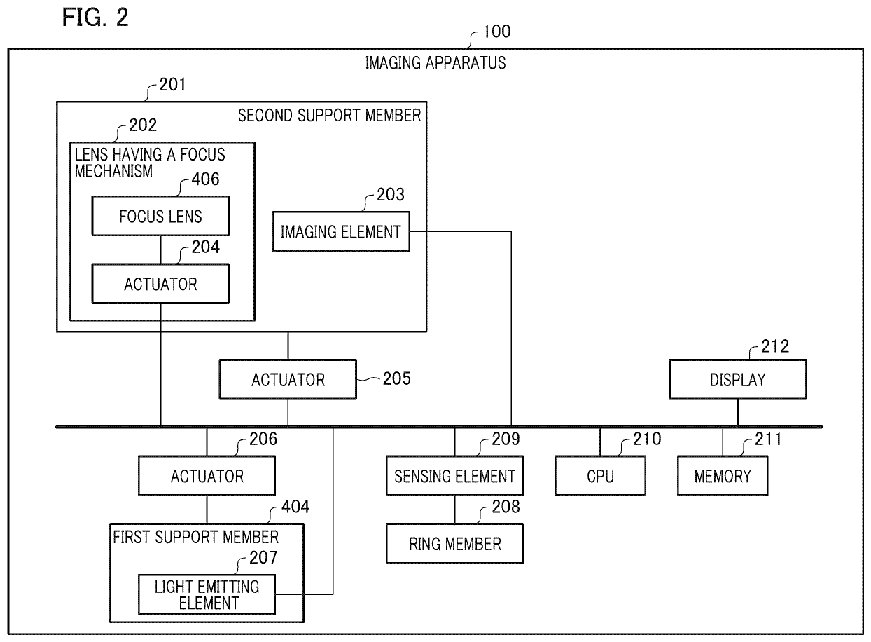

FIG. 2 is a hardware configuration diagram of the imaging apparatus 100 in the first embodiment. A second supporting member 201 that is a camera module supports a lens 202 having a focus mechanism and an imaging element 203 that is an element that captures terahertz waves.

For example, a focus lens 406 of the lens 202 having a focus mechanism is formed by using high-density polyethylene (High-density polyethylene: HDPE) as a material. The focus lens 406 may also use high-resistance silicon or Teflon (registered trademark) (Poly Tetra Fluoro Ethylene: PTFE) as a material.

The focus lens 406 of the lens 202 having a focus mechanism may be a single focus lens, or may be a zoom lens in which focal length is variable. Additionally, the focus lens 406 of the lens 202 having a focus mechanism may include an aperture. An actuator 204 for changing the position of the focus lens 406 is connected to the lens 202 having a focus mechanism.

The actuator 204 is configured by a motor, a gear, a motor driver, and the like, and can change an in-focus position by changing the position of the focus lens 406. The lens 202 having a focus mechanism corresponds to the image forming optical system 101 in the functional block diagram of FIG. 1, and the actuator 204 corresponds to the focus changing unit 102 in the functional block diagram of FIG. 1.

The imaging element 203 corresponds to the imaging unit 103 in the functional block diagram of FIG. 1, and is configured by using, for example, a Schottky barrier diode, a bolometer, a MEMS resonator, and the like.

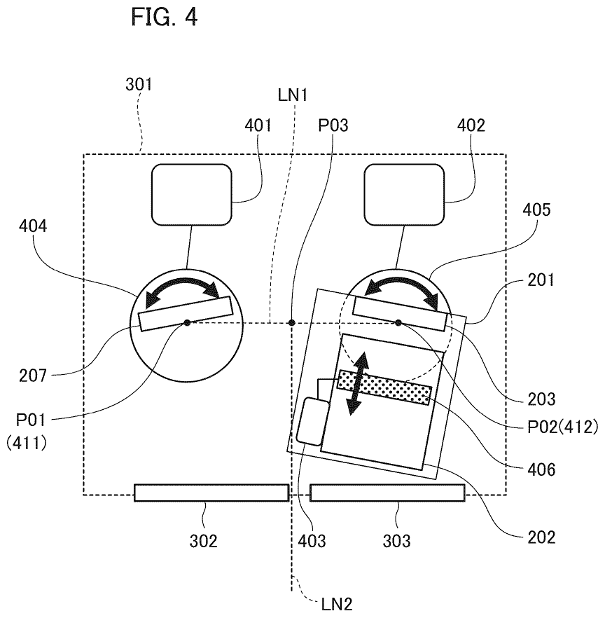

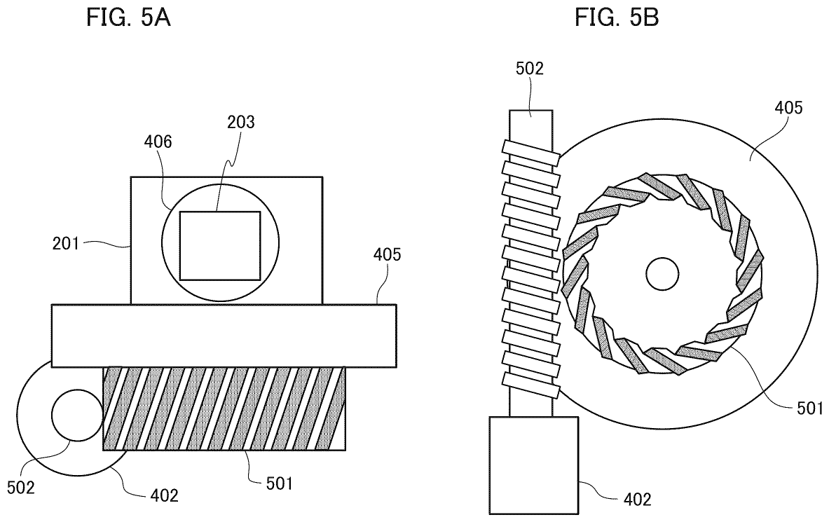

An actuator 205 for changing an angle is connected to the second support member 201. The actuator 205 is configured by a motor, a gear, a motor driver, and the like. The actuator 205 corresponds to the second rotation unit 104 in FIG. 1, and is configured by a motor, a gear, a motor driver, and the like, similarly to the actuator 204. More details will be described below with reference to FIG. 4, FIG. 5A and FIG. 5B.

A light emitting element 207 that emits terahertz waves corresponds to the illumination unit 105 in the functional block diagram of FIG. 1, and for example, an antenna composed of a differential negative resistance element and a resonance circuit is used. As the differential negative resistance element, a resonant tunnel diode and the like are used. Additionally, the light emitting element 207 may be configured by a plurality of light emitting elements. When a plurality of light emitting elements are resonantly driven, the light emission intensity can be increased.

The light emitting element 207 is supported by a first support member 404, and an actuator 206 for changing the angle of the light emitting element 207 is connected to a first support member 404.

The actuator 206 corresponds to the first rotation unit 106 in the functional block diagram of FIG. 1 and is configured by a motor, a gear, a motor driver, and the like, similarly to the actuators 204 and 205. Specific configurations will be described below with reference to FIG. 4, FIG. 5A, and FIG. 5B.

Additionally, the first support member 404 and the second support member 201 are movably supported by the housing of the imaging apparatus 100. The light emitting element 207 may be provided with a lens for controlling a condensing light range. As the lens, high-density polyethylene, high-resistance silicon, and Teflon (registered trademark) can be used similarly to the focus lens 406 of the lens 202 having a focus mechanism. In a case in which a lens is provided, a configuration in which both the angle of the lens and the angle of the light emitting element 207 may be changed by the actuator 206 may be adopted.

A ring member 208 and a sensing element 209 correspond to the input unit 109 in the functional block diagram of FIG. 1, which serve as an operation unit that allows the user to input set distance information that is a set value of the distance from the imaging element 203 to the subject. The ring member 208 is used when the user changes the orientation such as the angles of the first support member 404 and the second support member 201. The user rotates the ring member 208 and a signal corresponding to the rotation amount is output from the sensing element 209 and transmitted to a central processing unit (CPU) 210 to be described below.

As the sensing element 209, for example, a rotary encoder, a photo interrupter, a magnetic sensor, and the like are used. The ring member 208 and the sensing element 209 may be configured by other components provided that an operation amount of a user can be detected. For example, as the ring member 208, a structure such as a zoom lever in a video camera and a jog dial used in an AV device may be used. In addition, as the ring member 208, a structure including a cross key and a stick lever may be used. In the case of using the zoom lever type structure, as the sensing element 209, a magnetic sensor, a photo interrupter, a plurality of electrical contacts, and the like can be used. In the first embodiment, as an example, a case in which a ring member and a rotary encoder are used will be explained.

The CPU 210 is configured by a dedicated circuit such as an application specific integrated circuit (ASIC) and a processor such as a field programmable gate array (FPGA). A memory 211 is configured by a volatile memory such as a random-access memory (RAM) and a non-volatile memory such as a read only memory (ROM). Some of the functional blocks of the imaging apparatus 100 as shown in FIG. 1 are realized by causing the CPU 210 that is an executing unit to execute a computer program stored in the memory 211.

A display 212 corresponds to the display unit 108 in the functional block diagram of FIG. 1, and is configured by a liquid crystal display, an organic EL display, a cathode-ray tube, and the like. The display 212 may be provided outside the imaging apparatus 100 and configured to transfer display data from the imaging apparatus 100 by wired or wireless communication.

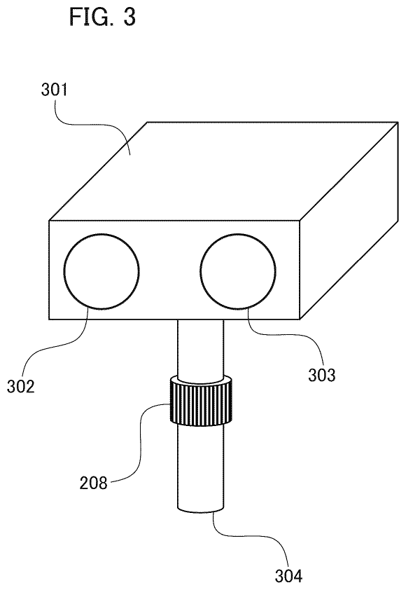

FIG. 3 illustrates an example of an external appearance of the imaging apparatus 100. The imaging apparatus 100 is configured by a camera head 301 that is a housing, and a handle 304. The first support member 404 and the second support member 201 are arranged inside the camera head 301 (not illustrated). The internal structure of the camera head will be explained in detail with reference to FIG. 4.

The camera head 301 is provided with an opening window 302 for the light emitting element 207 and an opening window 303 for the imaging element 203. The opening windows 302 and 303 may be configured by high-density polyethylene, high-resistance silicon, or Teflon (registered trademark), for example, or may be simply cut-out holes.

The handle 304 is provided with the ring member 208 for the user to operate. When the user rotates the ring member 208 that serves as the input unit 109, information corresponding to the setting distance information that is a setting value of the distance from the imaging element 203 to the subject is input. A rotary encoder that performs sensing of the rotation amount (not illustrated) is provided inside the ring member 208. The ring member 208 is configured so that angles of the first supporting member 404 and the second supporting member 201 inside the camera head 301 change according to a rotation amount of the ring member 208.

FIG. 4 is a perspective view of the camera head 301 in FIG. 3 as viewed from above. Inside the camera head 301, the light emitting element 207, an imaging element 203, and the focus lens 406 are arranged as shown in the drawing. The light emitting element 207 is supported by the first support member 404.

A motor 401 is disposed in the housing, and the first rotation unit 106 rotates the first support member 404 with respect to the housing by the rotation of the motor 401. The light emitting element 207 supported by the first supporting member 404 has the angle of the light emitting element 207 with respect to the housing changed by rotation of the motor 401. In FIG. 4, a straight line connecting the center P01 of the light emitting element 207 and the center P02 of the imaging element 203 is denoted by LN1. A rotation shaft 411 of the first supporting member 404 passes through a midpoint P03 of the straight line LN1, is perpendicular to a plane including a straight line LN2 extending in a direction of a subject, and passes through the center P01 of the light emitting element 207. In this context, the center of the light emitting element 207 means the center of a region in which a plurality of light emitting elements are arranged in a case in which the light emitting element 207 includes a plurality of light emitting elements. Details of the first rotation unit 106 will be described below with reference to FIG. 5A and FIG. 5B.

In FIG. 4, the imaging element 203 and the lens 202 having the focus mechanism are supported by the second support member 201. A motor 402 is disposed in the housing, the second rotation unit 104 rotates the second support member 201 with respect to the housing by the rotation of the motor, and the angle of the imaging element 203 with respect to the housing is changed.

In FIG. 4, a rotation shaft 412 of the second support member 201 is an axis that passes through the center P02 of the imaging element 203 and is parallel to the rotation shaft 411. The center of the imaging element 203 means the center of a region in which a plurality of light receiving elements of the imaging element 203 are arranged. Details of the second rotation unit 104 will be described below with reference to FIG. 5A and FIG. 5B. When the second support member 201 is rotated by the second rotation unit 104, the direction of the imaging is changed.

In FIG. 4, the lens 202 having the focus mechanism is provided with a focus lens 406 and a motor 403 for driving the focus lens 406. The focus position is changed by the motor 403 moving the focus lens 406 in an optical axis direction of the lens.

FIG. 5A and FIG. 5B are diagrams for explaining the rotation unit in FIG. 4. FIG. 5A is a view of a second support member 405 in FIG. 4 as viewed from the side, represents a structure when viewed from the front of the second supporting member 201 in the direction of the imaging element 203. FIG. 5B is a view of the second supporting member 201 as viewed from below.

First, in FIG. 5A, as explained in FIG. 4, the lens 202 having a focus mechanism and the imaging element 203 are supported by the second support member 201. The second supporting member 405 that is integrally provided with the second supporting member 201 is provided with a helical gear 501, and a worm 502 that is connected to a shaft of the motor 401 is meshed with the helical gear 501.

As shown in FIG. 5B, the second rotation unit 104 includes a motor 402 that serves as a drive source, and the worm 502 and the helical gear 501 that serve as a transmission mechanism for transmitting the rotation of the motor 402 to the second support member 201. Similarly, the first rotation unit 106 of the first support member 404 also includes the motor 401 that serves as a drive source, and a worm and a helical gear that serve as a transmission mechanism that transmits the rotation of the motor 401 to the first support member 404.

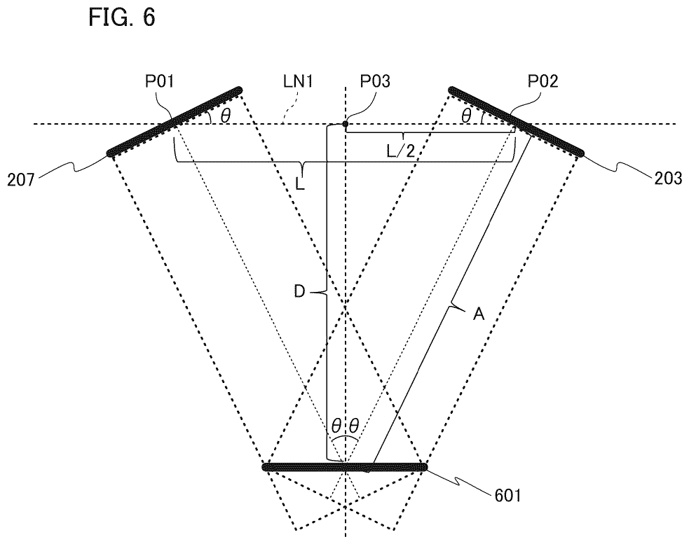

FIG. 6 is a diagram for explaining a positional relationship between the light emitting element 207, the imaging element 203, and a subject in image capturing using terahertz light. The light emitting element 207 and the imaging element 203 are arranged at an angle facing the subject 601. In the drawing, θ represents an angle formed by the straight line LN1 connecting the center P01 of the light emitting element 207 and the center P02 of the imaging element 203, and each of the light emitting element 207 and the imaging element 203. Hereinafter, θ is referred to as a tilt angle.

In the drawing, D represents the distance from the midpoint P03 of the straight line LN1 connecting the center P01 of the light emitting element 207 and the center P02 of the imaging element 203 to a subject 601. In the drawing, L represents the length of a straight line connecting the center P01 of the light emitting element 207 and the center P02 of the imaging element 203. In the drawing, A represents the distance between the center P02 of the imaging element 203 and the subject 601.

As described above, since the terahertz wave has a relatively longer wavelength than surface irregularities of the subject, the terahertz wave irradiated on the surface of the subject does not scatter but undergoes specular reflection. That is, the imaging element 203 can acquire only a component of the terahertz wave irradiated from the light emitting element 207 that is specularly reflected on the surface of the subject 601.

In a case in which the positional relation shown in FIG. 6 is the case, most of the terahertz waves regularly reflected by the subject 601 can be made incident on the imaging element 203. If the subject 601 moves from the position in FIG. 6 by approaching the imaging apparatus 100 side or moving away from the imaging apparatus 100 side, the terahertz wave irradiated from the light emitting element 207 does not hit the subject 601. Additionally, even when the terahertz wave hits the subject 601, only a part of the specularly reflected terahertz light is made incident on the imaging element 203. That is, the subject is not captured at all or only a part of the subject is captured within the imaging range.

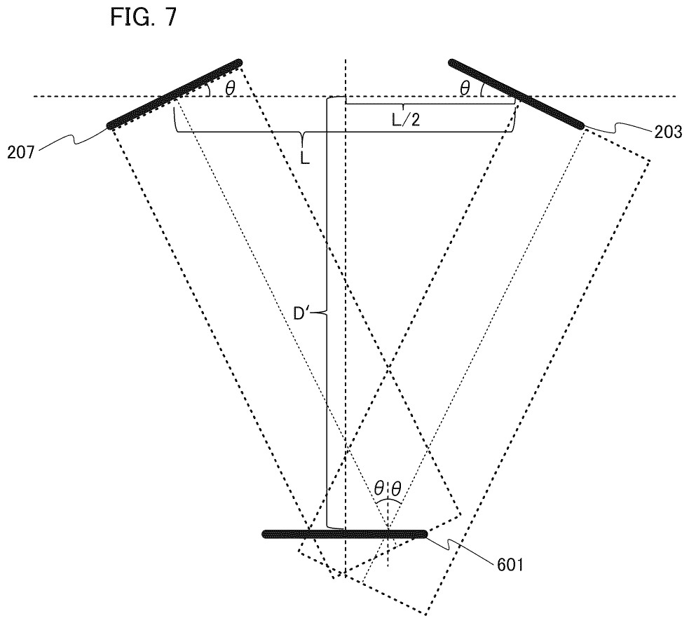

FIG. 7 is a diagram of a case in which the subject is farther away than in FIG. 6 (D′>D). Only a part of the terahertz wave irradiated from the light emitting element 207 hits the subject and specularly reflected, and only a part of the reflected light is made incident on the imaging element 203, and as a result, only part of the subject 601 is imaged.

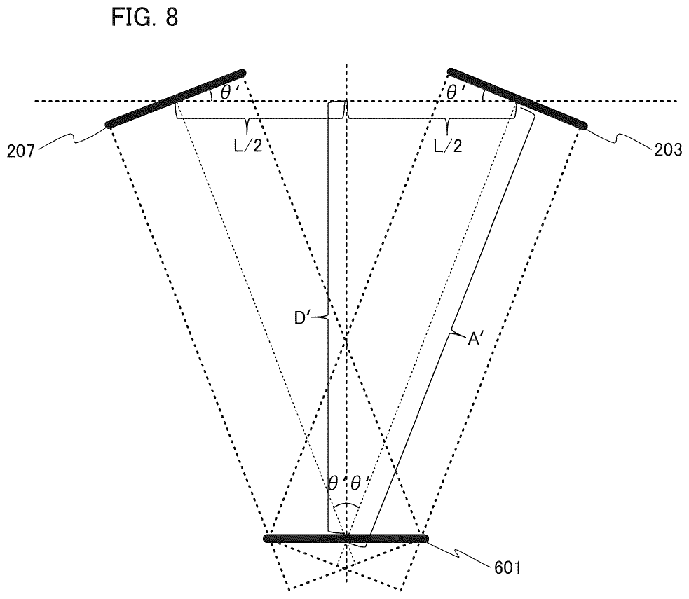

In FIG. 8, the tilt angle of the light emitting element 207 and the imaging element 203 is changed (θ′<θ) so that the subject 601 at the position in FIG. 7 can be imaged. The tilt angle is changed in this way, so that image capture of the subject 601 that is away from the imaging apparatus is possible. Although the drawing for a case in which the subject 601 has approached is omitted, the subject 601 can be captured by making the tilt angle larger. However, even if the tilt angle of the imaging element 203 is not changed to θ′, the terahertz wave regularly reflected on the subject 601 is made incident, and therefore, image capture itself is possible. That is, in a configuration in which the tilt angle of the light emitting element 207 is changed and the tilt angle of the imaging element 203 is not changed, the adjustment of the illumination angle and the focusing can be performed simultaneously, thereby making it possible to shorten the time until imaging can be started as intended by the user. Accordingly, the configuration of the first embodiment includes the following configuration in which the tilt angle of the light emitting element 207 is changed and the tilt angle of the imaging element 203 is not changed. The imaging apparatus includes a light emitting element, an imaging element, a focus lens, an image forming optical system, a support member, and a housing. Then, the execution unit of the imaging apparatus executes the change of the orientation of the support member by the orientation changing unit and the change of the position of the focus lens by the focus changing unit based on the setting distance information input to the input unit.

In contrast, since the terahertz wave is obliquely incident on the imaging element 203, shading may occur. Therefore, it is desirable that the tilt angle of the image sensor 203 is also changed to θ′. That is, it is desirable that the angle at which the first support member 404 is rotated by the first rotation unit 106 is equal to the angle at which the second support member 201 is rotated by the second rotation unit 104. Additionally, as is clear from FIG. 6 and FIG. 8, the direction in which the first support member 404 is rotated by the first rotation unit 106 is opposite to the direction in which the second support member 201 is rotated by the second rotation unit 104.

Next, a focus position will be explained with reference to FIG. 6 and FIG. 8. Because θ and L in FIG. 6 are design values of the imaging apparatus 100, they are known values. The distance A between the subject 601 and the imaging element 203 can be calculated by: A=L/(2 sin θ) . . . (1).

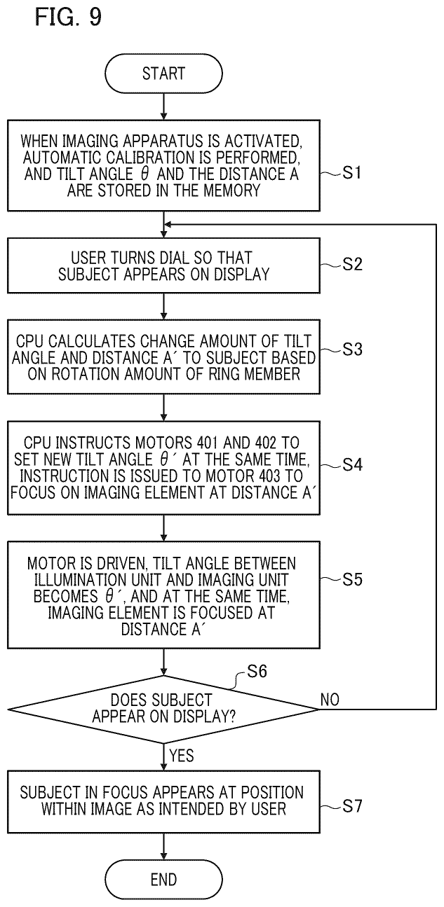

Even when the position of the subject changes as shown in FIG. 8, calculation can be made by Formula (1) using the new tilt angle θ′. That is, the position of the focus lens 406 necessary for focusing can be uniquely obtained from the value calculated by Formula (1). How to set the tilt angle θ itself will be explained with reference to FIG. 9.

FIG. 9 is a flowchart illustrating internal processing of the image capturing apparatus 100 when the user captures images by using the imaging apparatus 100. The explanation will be made assuming that the subject 601 is at a distance at which image capturing is not possible with the initial value of the tilt angle.
(S1) The CPU 210 performs automatic calibration when the imaging apparatus 100 is activated, and transmits the tilt angle θ at the start of imaging and the distance A to the subject to the memory 211. The position of the flag is arranged in advance so that the tilt angle θ when the sensor provided in the housing detects the flag attached to the second support member 405 becomes a predetermined angle.
(S2) While the user checks the captured image displayed on the display 212, the ring member 208 of the handle 304 is rotated so that the subject 601 appears on the display 212.
(S3) At this time, the amount of rotation of the ring member 208 from the start is converted into a signal by the rotary encoder that serves as the sensing element 209, and the signal is transmitted to the CPU 210 that serves as the executing unit.
(S4) The CPU 210 calculates an amount of change in the tilt angle θ of the light emitting element 207 and the imaging element 203 according to the amount of rotation, and provides a drive instruction to the motors 401 and 402. At the same time, the CPU 210 calculates a distance A′ corresponding to the new tilt angle θ′ by Formula (1), and issues a driving instruction to the motor 403 to move the focus lens 406 to a position at which the focus is on the distance A′.

The change amount of the tilt angle with respect to the rotation amount of the ring member 208 may be set to any value. When the set value is large, the user can change the tilt angle quickly. However, fine adjustment becomes difficult. In contrast, when the set value is small, fine adjustment of the tilt angle is easy. However, it takes time when the tilt angle is significantly changed.
(S5) The CPU 210 rotates the motors 401 and 402 to rotate the first support member 404 and the second support member 201, and sets the tilt angle to θ′. At the same time, the CPU 210 rotates the motor 403, and the focus lens 406 is moved to a position at which the imaging element 203 is in focus at the distance A′.
(S6) In a case in which the subject 601 is not displayed on the display 212, the process returns to S1 and user turns the ring member 208 again. In a case in which an appropriate tilt angle corresponding to the distance to the subject 601 can be set, the subject 601 is displayed on the display 212 in this step. As the subject 601 gradually appears on the display 212 during the transition from (S5) to (S6), the focus also asymptotically approaches the in-focus state, and thus the user can see a captured image that is substantially in focus, and the user can perform fine adjustment of the imaging range at this point in time.
(S7) At the same time as the subject 601 is placed within the display 212, focusing on the subject 601 is completed, and image capturing as intended by the user becomes possible.

In step (S6) of FIG. 9, although the user searches for an appropriate tilt angle by trial and error, the CPU 210 may cause the display 212 to display the distance within which the image can be captured at the current tilt angle so that the appropriate tilt angle can be set more quickly. In addition, the CPU 210 may display an icon or a message on the display 212 so that the rotation direction of the ring member 208 and the change direction of proximity or distance of the image capturing distance are understood.

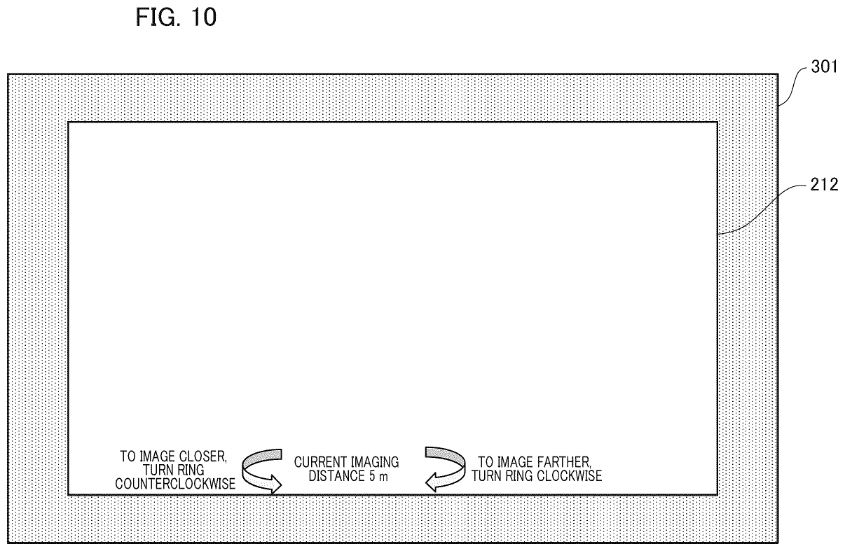

FIG. 10 illustrates an example of a display. FIG. 10 is a rear view of the imaging apparatus 100 of FIG. 3. A display 212 is disposed on the back surface of the camera head 301. For the display of “current imaging distance”, it is sufficient to display a distance D that can be calculated from the current tilt angle θ by the following Formula (2).

$$D = L / ( 2 tan θ ) \qquad ( 2 )$$

The rotation direction of the ring member 208 and the direction of change in proximity or distance of the imaging distance may be displayed on the display 212 as shown in FIG. 10, or may be printed or engraved on, for example, the housing of the camera head 301, without being displayed on the display 212.

### Second Embodiment

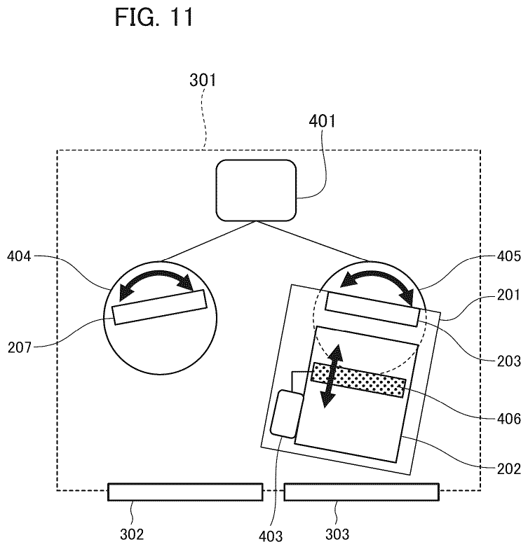

In the second embodiment, a case in which one motor is eliminated from the first embodiment will be explained. FIG. 11 is a perspective view of the camera head 301 as viewed from above. The motor 402 in FIG. 4 is eliminated, and the motor 401 is configured to drive both the first support member 404 and the second support member 405. Since other components are the same as those in FIG. 4, the explanation thereof will be omitted.

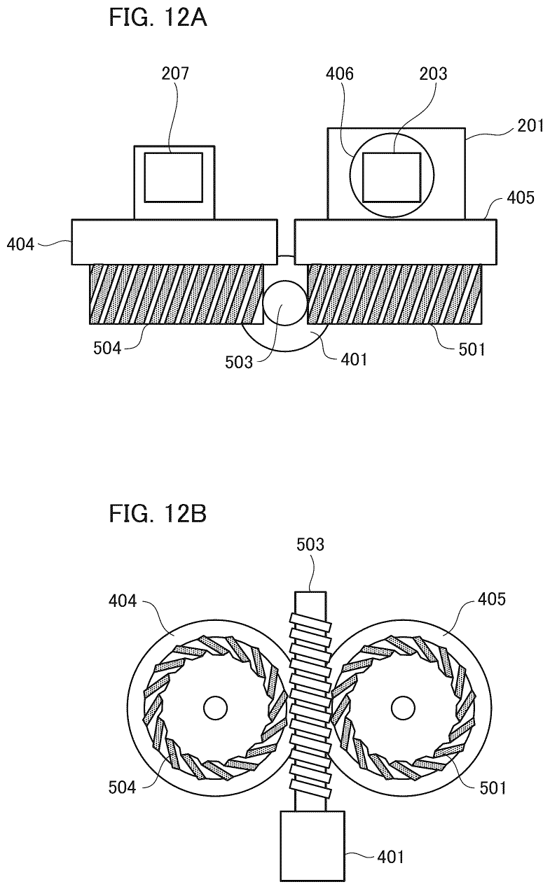

The motor 401, the first support member 404, and the second support member 201 have the configuration as shown in FIG. 12A when viewed from the lateral side. A worm 503 that is connected to the shaft of the motor 401 is meshed with both the helical gear 501 and the helical gear 504. The angles of the gear of the helical gear 501 and the helical gear 504 are reversed so as to rotate in opposite directions to each other.

Furthermore, a case in which the structure of FIG. 12A when viewed from the lower side is shown in FIG. 12B. When the worm 503 rotates, the helical gear 501 and the helical gear 504 rotate in opposite directions to each other. The first rotation unit 106 that rotates the first support member 404 includes the motor 401 that serves as a rotatable drive source and the helical gear 504 that serves as a first transmission mechanism that transmits the rotation of the motor 401 to the first support member 404.

In addition, the second rotation unit 104 that rotates the second support member 201 includes the helical gear 501 that serves as a transmission mechanism that transmits the rotation of the motor 401 to the second support member 201. By adopting such a configuration, one motor can be eliminated compared to the first embodiment, thereby making it possible to reduce the size and cost of the imaging apparatus.

### Third Embodiment

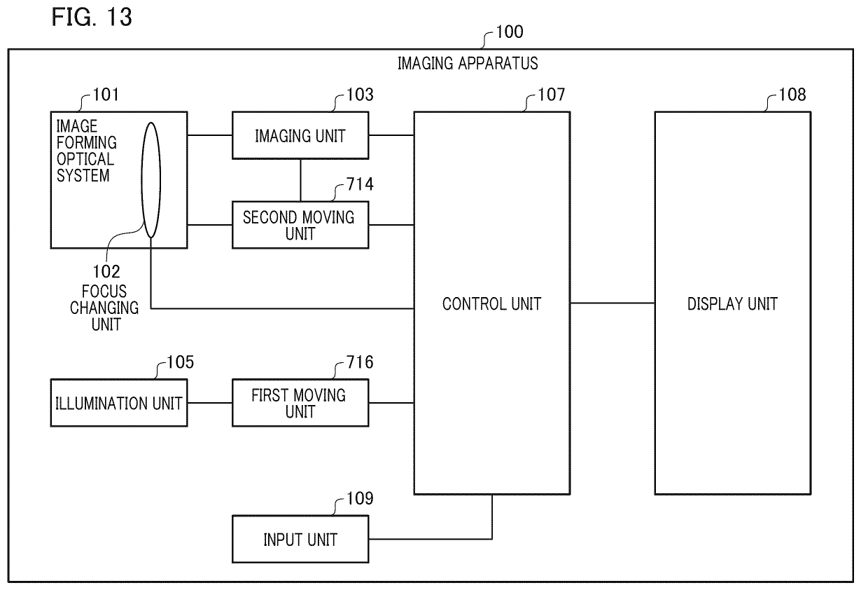

FIG. 13 is a functional block diagram of the third embodiment. In the third embodiment, a configuration is adopted in which a first moving unit 716 and the second moving unit 714 cause the light emitting element 207 and the imaging element 203 to move, instead of rotating the light emitting element 207 and the imaging element 203 by the rotation unit.

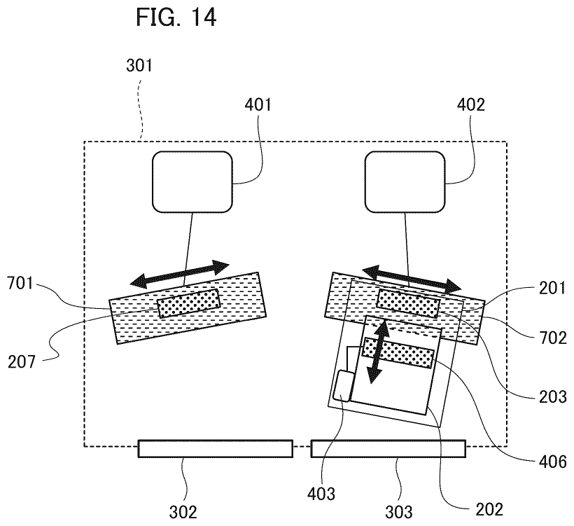

FIG. 14 is a perspective view of the camera head 301 of the third embodiment as viewed from above. A first support member 701 supports the light emitting element 207, and the second support member 201 supports the imaging element 203 and the focus lens 406.

In the third embodiment, the first orientation changing unit is the first moving unit 716, and moves the first support member 701 by the motor 401, a pinion 703, and the rack. The second orientation changing unit is a second moving unit 714 and moves a second support member 702 by the motor 402, a pinion, and a rack.

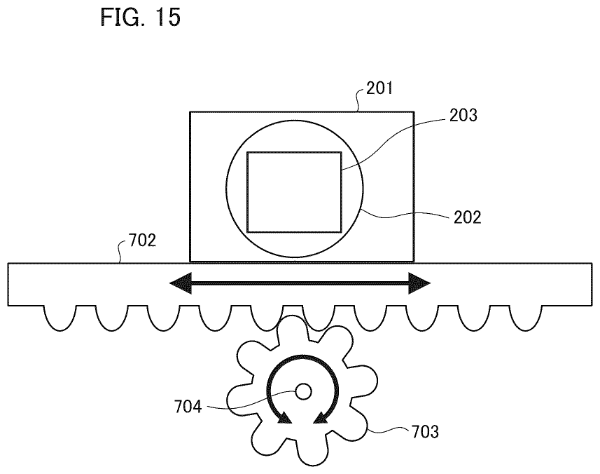

The first support member 701 is moved by the first moving unit 716 in the moving direction indicated by the arrow, and the second support member 201 is moved by the second moving unit 714 in the moving direction indicated by the arrow. The mechanism and operation of the moving unit will be explained in detail below with reference to FIG. 15. Since the other configurations are the same as those of the first embodiment, the explanation thereof will be omitted.

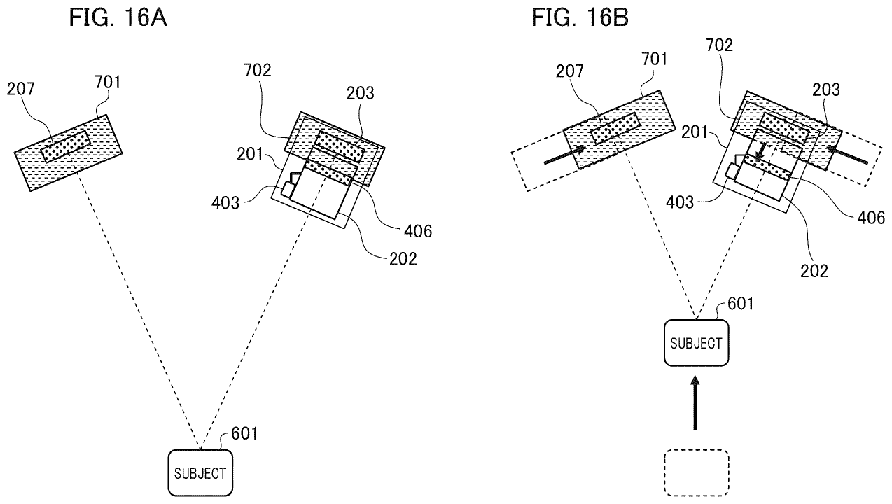

FIG. 15 is a view showing the second support member 201 as viewed from the front direction. Gear cutting is performed on the lower side of the second support member 201, and a rack is formed. The pinion 703 meshes with the rack of the second support member 201, and the pinion 703 is attached to a motor shaft 704 of the motor 402 placed on the far side of the drawing (not illustrated). When the motor 402 rotates the pinion 703, the second support member 201 moves to the left and right direction in the drawing according to the rotation direction. Since the first support member 701 has the same configuration, the explanation thereof will be omitted. The change in the distance from the imaging element 203 to the subject using this moving unit will be explained with reference to FIG. 16A and FIG. 16B.

FIG. 16A and FIG. 16B are diagrams for explaining the movement of the positions of the first support member 701 and the second support member 201 when a distance between the subject 601 and the imaging apparatus 100 is changed. FIG. 16A shows a state in which a subject 601 at a certain distance can be imaged. FIG. 16B shows the positions of the first support member 701 and the second support member 201 after their movement when the subject 601 approaches the imaging apparatus 100 side from the position in FIG. 16A.

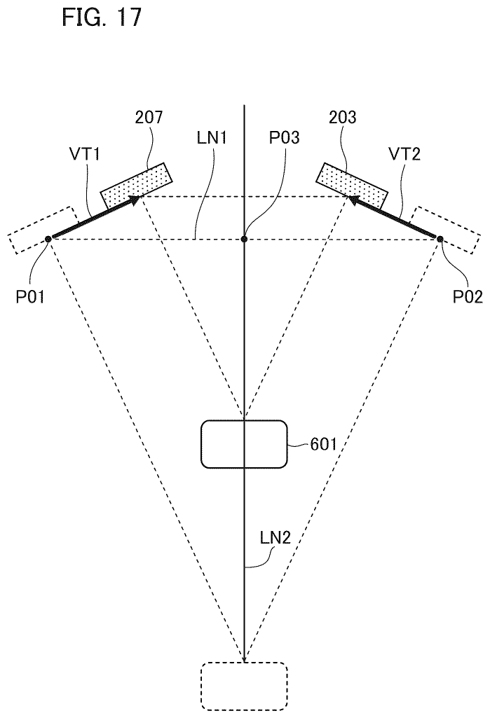

FIG. 17 is a diagram explaining changes in the positional relation of the light emitting element 207 and the imaging element 203 before and after the movement thereof by the first moving unit 716 and the second moving unit 714. The moving direction of the light emitting element 207 and the moving direction of the imaging element 203 will be explained with reference to FIG. 17.

In FIG. 17, a straight line connecting the center P01 of the light emitting element 207 and the center P02 of the imaging element 203 is denoted by LN1, the midpoint of the straight line LN1 is denoted by P03, and a straight line passing through the midpoint P03 and extending in the direction of the subject 601 is denoted by a first straight line LN2. The moving direction of the center of the light emitting element 207 in the third embodiment is a direction VT1 that is parallel to a plane including the straight line LN1 and the first straight line LN2 and that intersects the first straight line LN2.

Additionally, the moving direction of the center of the imaging element 203 is a direction VT2 that is parallel to a plane including the straight line LN1 and the first straight line LN2 and crossing the first straight line LN2. Additionally, the length of VT1 indicates the moving distance of the center of the light emitting element 207, and the length of VT2 indicates the moving distance of the center of the imaging element 203. That is, VT1 indicates a moving direction and a moving distance of the center of the light emitting element 207, and VT2 indicates a moving direction and a moving distance of the center of the imaging element 203.

As shown in FIG. 17, the moving direction and the moving distance of the center of the light emitting element 207 by the first moving unit 716 and the moving direction and the moving distance of the center of the imaging element 203 by the second moving unit 714 are in a line-symmetric relation with respect to the first straight line LN2.

When the first support member 701 and the second support member 201 are moved in a direction approaching to each other by using such a configuration, the terahertz wave hits the subject 601 that has approached, and the reflected terahertz wave can be made incident on the imaging element 203.

Additionally, the moving distance of the focus lens 406 can be calculated as follows. The distance L between the center of the light emitting element 207 and the center of the imaging element 203, and the moving direction and the moving distance by the first moving unit 716 and the second moving unit 714 are known. Therefore, the position (moving distance) to which the focus lens 406 is to be moved can be uniquely calculated using Formula (1) as described above. Thus, similarly to the first embodiment, after the user inputs the set distance information, the movement of the light emitting element 207 and the imaging element 203 and the focusing of the subject image on the imaging element can be performed without a time delay.

Additionally, in the third embodiment, the imaging apparatus 100 can capture images even if the subject moves in a lateral direction with respect to the imaging apparatus 100.

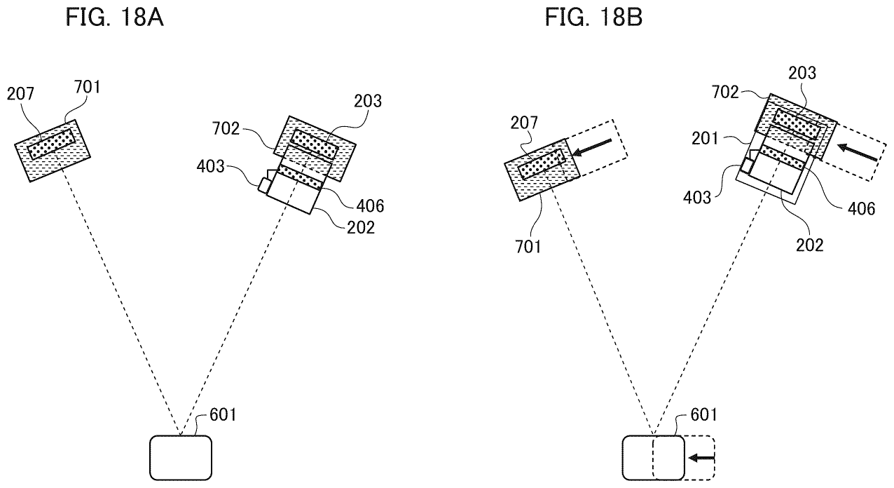

A case in which the subject 601 moves to the left as shown in FIG. 18A from a state in which an image of the subject 601 can be captured as shown in FIG. 18B will be explained. As described above, since in the imaging with the terahertz waves, the regular reflected components are imaged, even when the subject 601 moves to any of the front, rear, left, and right from the position of the subject 601 in FIG. 18A, the specular reflection relationship is broken, and the subject 601 deviates from the imaging range. In such a case, as shown in FIG. 18B, the light emitting element 207 is moved in the lower left direction of FIG. 18B and the imaging element 203 is moved in the upper left direction of FIG. 18B by the same amount. By this movement, the terahertz wave irradiated by the light emitting element 207 hits the subject 601 that has moved in the lateral direction, and it becomes possible to input the specularly reflected component into the imaging element 203.

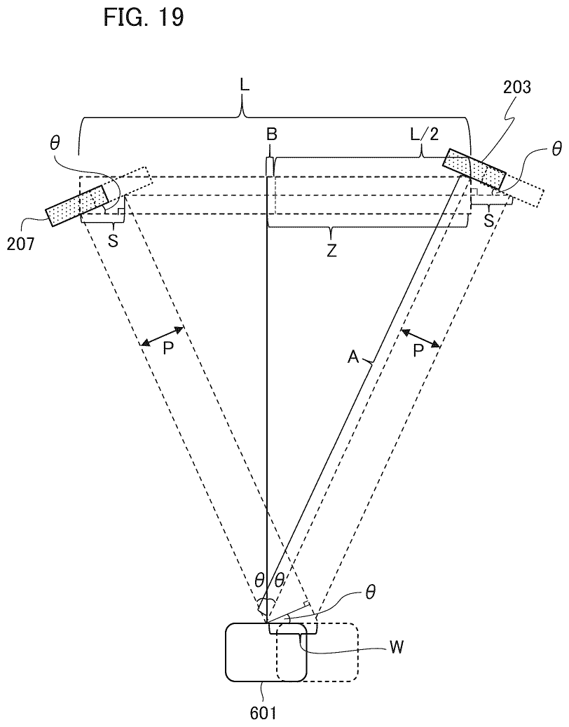

FIG. 19 is a diagram for explaining the relation between the moving amounts of the light emitting element 207 and the imaging element 203 and the distance A from the imaging element 203 to the subject 601 when the subject moves in the lateral direction. FIG. 19 illustrates the position after the subject 601 has moved in the left direction of FIG. 19, and the dotted frame indicates the position before the subject 601 has moved. The moving amount of the subject 601 at this time is denoted by W. The light emitting element 207 moves in the lower left direction in FIG. 19, and the imaging element 203 moves in the upper left direction in FIG. 19, each by the same amount from the original position indicated by the dotted frame. This moving amount is denoted by P. Since the tilt angle does not change from θ before and after the movement, if the amount by which the light emitting element 207 has moved is denoted as S, S is calculated by the following Formula (3).

$$S = P cos θ \qquad ( 3 )$$

The same applies to the imaging element 203. In contrast, for the moving amounts W and P of the subject 601 in the horizontal direction, the following Formula (4) is established.

$$W = P / cos θ \qquad ( 4 )$$

When a difference between the moving amount S of the light emitting element 207 and the imaging element 203 and the moving amount W of the subject 601 is denoted by B, the difference is calculated as follows from Formulae (3) and (4).

$$B = W - S = P / cos θ - P cos θ \qquad ( 5 )$$

Assuming that the distance between the centers of the light emitting element 207 and the imaging element 203 is L, the value of L does not change even after the movement because both the light emitting element 207 and the imaging element 203 have moved in the left direction by S. L is a design value of the imaging apparatus 100, and therefore is a known value. In a case in which Z is defined as the distance from the intersection point of the straight line connecting the centers of the light emitting element 207 and the imaging element 203 when a perpendicular line is drawn in the vertical direction in the drawing from the center of the subject 601 after being moved, to the imaging element 203, Z is calculated by the following equation (6).

$$Z = L / 2 + B \qquad ( 6 )$$

Accordingly, the distance A from the imaging element 203 to the subject 601 can be calculated by the following Formula (7).

$$A = Z / sin θ = ( L / 2 + B ) / sin θ = ( L / 2 + P / cos θ - P cos θ ) / sin θ \qquad ( 7 )$$

If the focus lens 406 is moved to a position where the subject image is focused on the imaging element 203 at the distance A obtained by Formula (7) at the same time as the movement of the light emitting element 207 and the imaging element 203, image capturing similar to the first embodiment is possible. Thus, in the third embodiment, by moving each of the light emitting element 207 and the imaging element 203, it is possible to accommodate not only the movement of the subject 601 in the front and rear directions but also the movement in the left and right directions.

Note that in the third embodiment as well, as explained in the first embodiment, since the terahertz wave specularly reflected by the subject 601 is made incident, the imaging itself is possible. That is, in a configuration in which the light emitting element 207 is moved and the imaging element 203 is not moved, the adjustment of the illumination position and the focusing can be performed simultaneously, thereby making it possible to shorten the time until the image capturing can be started as intended by the user. Accordingly, the configuration of the third embodiment includes a configuration in which the light emitting element 207 is moved and the imaging element 203 is not moved.

In the imaging apparatus 100 of the third embodiment, for easy operation, it is preferable that another ring member other than the ring member 208 as shown in FIG. 3 is further provided on the handle 304, wherein the ring member 208 is provided for the operation corresponding to the change in the front and rear directions of the subject and another ring member is provided for the operation corresponding to the change in the left right directions of the subject. Alternatively, a configuration in which a cross key or a joystick is provided instead of the ring member 208, wherein input in the up-down direction of the cross key or the joystick corresponds to front-rear movement of the subject, and input in the left-right direction of the cross key or the joystick corresponds to left-right movement of the subject, may be adopted.

### Fourth Embodiment

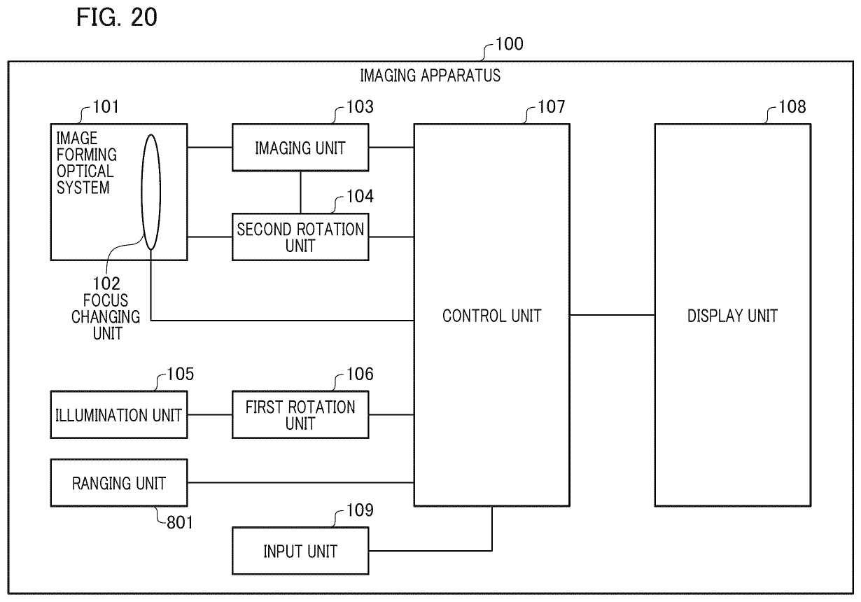

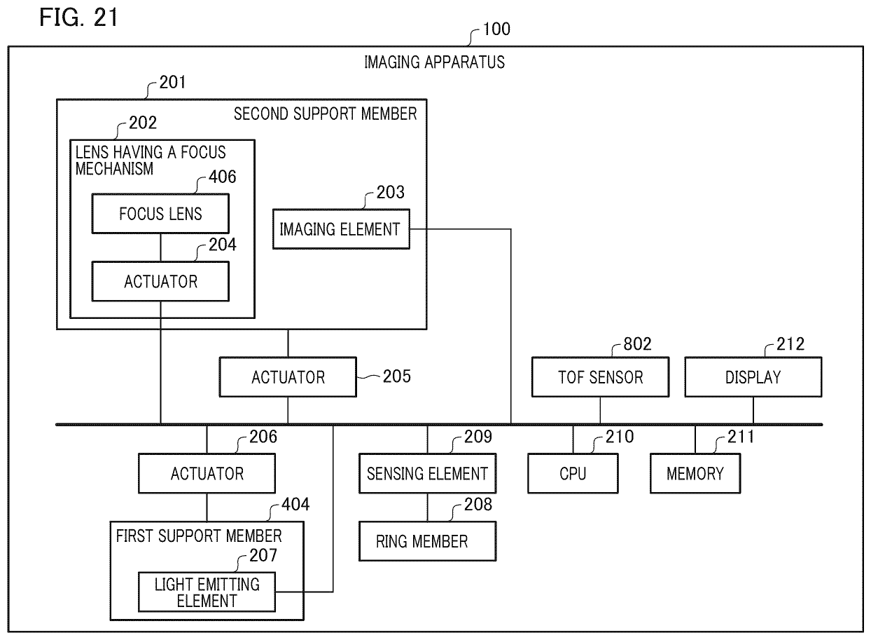

The fourth embodiment is a configuration in which a ranging unit is added to the imaging apparatus 100 of the first embodiment. FIG. 20 illustrates a functional block diagram. The imaging apparatus 100 includes a ranging unit 801 that serves as a ranging unit capable of measuring the distance to a subject. The set distance information input to the input unit 109 is transmitted to the control unit 107 and stored in the memory 211 of FIG. 21 as a target value. The measurement result obtained by the ranging unit 801 is transmitted to the control unit 107. The control unit 107 calculates an appropriate tilt angle θ and focus position according to the differences between the measured results and the target values and provides drive instructions to the first rotation unit 106, the second rotation unit 104, and the focus changing unit 102. As a result, the imaging unit 103 and the illumination unit 105 are set at a tilt angle θ corresponding to the set distance information with respect to the subject is set. Additionally, it is possible to simultaneously adjust the focus to the subject at the position of the setting distance information. Since the other components are the same as those of the first embodiment, the explanation thereof will be omitted.

FIG. 21 illustrates an example of the hardware configuration of the fourth embodiment. The imaging apparatus 100 is provided with a time of flight (TOF) sensor 802, which corresponds to the ranging unit 801 in FIG. 20. The TOF sensor 802 may be replaced by a ranging sensor configured by a radar or an ultrasonic sensor. Since the other components are the same as those of the first embodiment, the explanation thereof will be omitted.

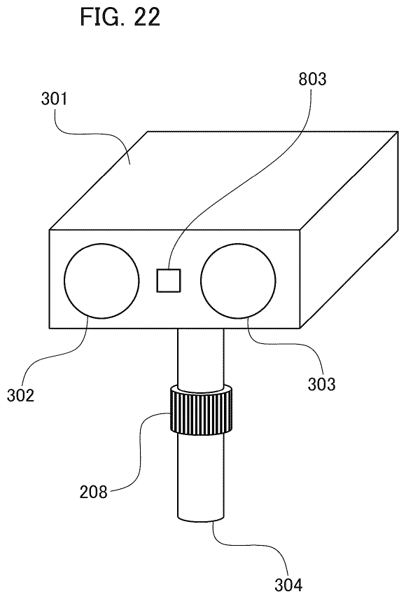

FIG. 22 illustrates an appearance of the imaging apparatus 100 of the fourth embodiment. An opening window 803 for a ranging sensor is provided between the opening window 302 and the opening window 303. The opening window may be configured by material through which the light source of the TOF sensor can pass, and in a case in which the material is for infrared light, the opening window may be configured by glass or resin. Alternatively, the opening window may be simply a cut-out hole. Additionally, although the TOF sensor is configured to be provided inside the camera head 301, for example, the TOF sensor 802 may be provided on the upper portion of the camera head.

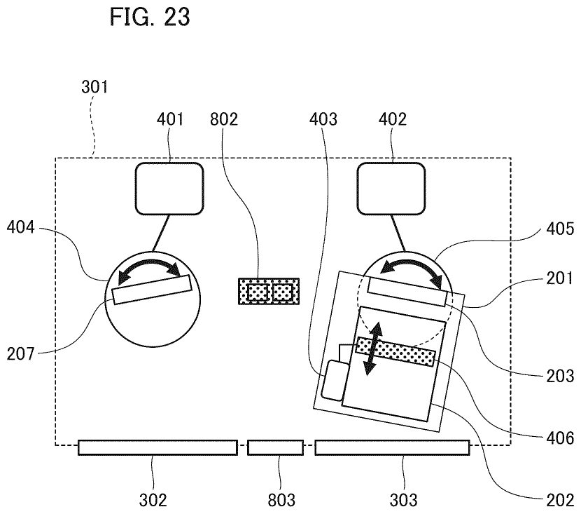

FIG. 23 is a perspective view of the imaging apparatus 100 as viewed from above. The TOF sensor 802 is provided at a midpoint between the light emitting element 207 and the imaging element 203.

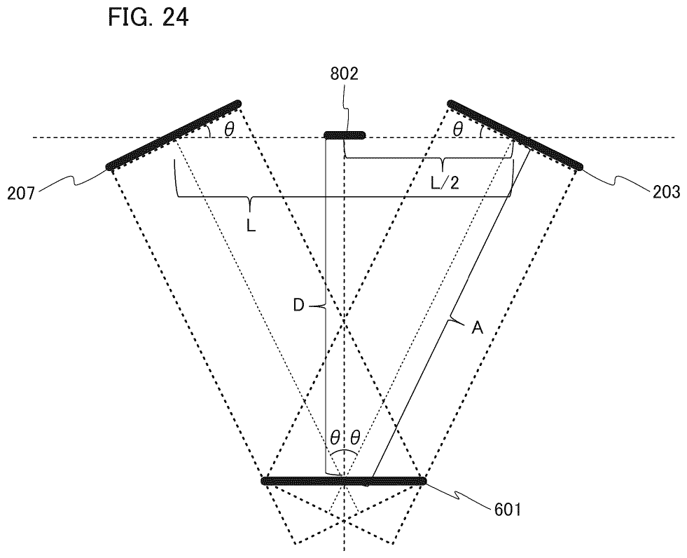

FIG. 24 is a diagram for explaining a positional relationship between the light emitting element 207, the imaging element 203, the subject 601, and the TOF sensor 802 of the fourth embodiment. Since D in the drawing becomes a known value by the ranging of the TOF sensor 802, the tilt angle θ of the light emitting element 207 and the imaging element 203 can be calculated from the following Formula (8).

$$θ = ark tan ( L / 2 D ) \qquad ( 8 )$$

In addition, the distance A from the imaging element 203 to the subject 601 can be calculated from Formula (1) described above.

Thus, since the tilt angle θ to be set and the distance A to be focused can be calculated from the ranging result of the TOF sensor 802, it is possible to simultaneously perform changing the tilt angle and focusing. Although the method of measuring the distance D using the TOF sensor 802 has been explained here, the TOF sensor 802 may be disposed adjacent to the imaging element 203 to measure the distance A. In this case, the tilt angle θ may be calculated from the following Formula (9).

$$θ = ark sin ( L / 2 A ) \qquad ( 9 )$$

In the fourth embodiment, since the ranging unit is added to the first embodiment, it is not necessary for the user to search for a tilt angle θ such that the subject 601 can be placed within the display 212, and it becomes possible to perform image capturing more easily.

### Fifth Embodiment

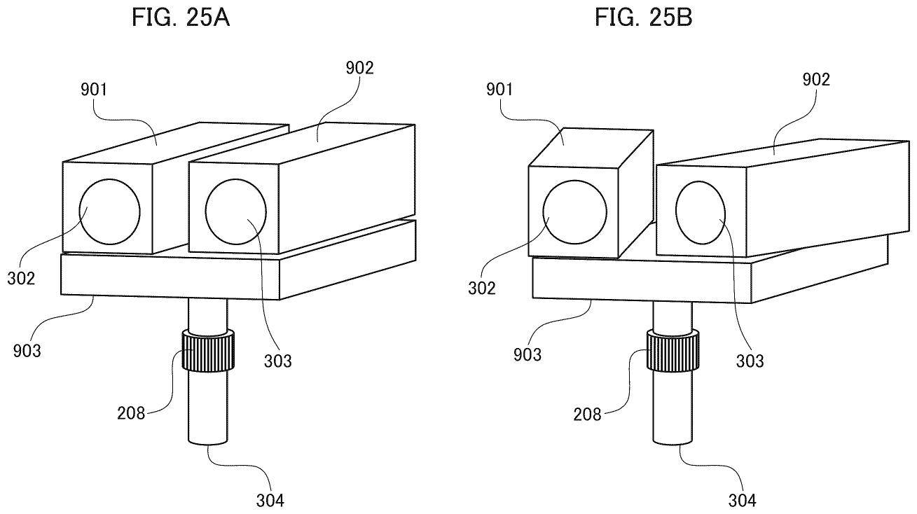

In the fifth embodiment, an example of a configuration in which the camera head 301 is divided will be explained. FIG. 25A and FIG. 25B illustrate diagrams when the imaging apparatus 100 is viewed obliquely from the front. In FIG. 25A, the portion that is the single camera head 301 in FIG. 3 is divided into three parts: a first camera head 901, a second camera head 902, and a fixing portion 903 that serves as housing. The light emitting element 207 is disposed in the first camera head 901, and the second support member 201 that supports the imaging element 203 and the lens 202 having a focus mechanism is disposed in the second camera head 902.

Additionally, in the fifth embodiment, the first support member 404 and the second support member 201 are the first camera head 901 and the second camera head 902. Rotation shafts are provided on each of the lower surface of the first camera head 901 and the lower surface of the second camera head 902. The two rotation shafts pass through holes (not illustrated) provided on the upper portion of the fixing portion 903 and are connected to a rotation unit provided in the fixing portion 903. Accordingly, a configuration is adopted in which the first camera head 901 and the second camera head 902 rotate as shown in FIG. 25B via each rotation shaft by each rotation of the motor 401 and the motor 402 provided in the fixed portion. By configuring in this manner, when the user performs setting of the tilt angle θ, there is an advantage that the user can easily recognize the directions in which the light emitting element 207 and the imaging element 203 are facing, and the setting becomes easier.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-80456, filed May 16 2024, which is hereby incorporated by reference wherein in its entirety.

Although the preferred embodiments of the present invention have been described above, the present invention is not limited to these embodiments, and various modifications and changes can be made within the scope of the gist thereof.

What is claimed is:

1. An imaging apparatus comprising:
a light emitting element configured to irradiate a subject with a terahertz wave;
an imaging element configured to detect a terahertz wave reflected by a subject;
an image forming optical system configured to include a focus lens and form an image of a terahertz wave reflected by a subject on the imaging element;
a support member that supports the light emitting element;
a housing that supports the support member;
at least one processor or circuit configured to function as:
an orientation changing unit configured to change an orientation of the support member with respect to the housing;
a focus changing unit configured to be provided in the image forming optical system and change the position of the focus lens;
an input unit configured to receive set distance information that is a set value of a distance from the imaging element to a subject; and
an execution unit configured to execute the change of an orientation of the support member by the orientation changing unit and the change of a position of the focus lens by the focus changing unit, based on the set distance information.

2. An imaging apparatus comprising:
a light emitting element configured to irradiate a subject with a terahertz wave;
an imaging element configured to detect a terahertz wave reflected by a subject;
an image forming optical system configured to include a focus lens and form an image of a terahertz wave reflected by a subject on the imaging element;
a first support member that supports the light emitting element;
a second support member that supports the imaging element and the image forming optical system;
a housing that supports the first support member and the second support member;
at least one processor or circuit configured to function as:
a first orientation changing unit configured to change an orientation of the first support member with respect to the housing;
a second orientation changing unit configured to change an orientation of the second support member with respect to the housing;
a focus changing unit configured to be provided in the image forming optical system and change the position of the focus lens;
an input unit configured to receive set distance information that is a set value of a distance from the imaging element to a subject; and
an execution unit configured to execute the change of an orientation of the first support member by the first orientation changing unit, the change of an orientation of the second support member by the second orientation changing unit, and the change of the position of the focus lens by the focus changing unit, based on the set distance information.

3. The imaging apparatus according to claim 2, wherein:
the first orientation changing unit is a first rotation unit configured to rotate the first support member with respect to the housing,
the second orientation changing unit is a second rotation unit configured to rotate the second support member with respect to the housing, and
the execution unit, based on the set distance information, rotates the first support member by the first rotation unit, rotates the second support member by the second rotation unit, and changes the position of the focus lens by the focus changing unit.

4. The imaging apparatus according to claim 3, wherein:
a rotation shaft of the first support member is a first axis that passes through a center of the light emitting element and is perpendicular to a plane including a straight line connecting the center of the light emitting element and the center of the imaging element, and a straight line that passes through a midpoint of the straight line and extends in a direction of the subject and,
a rotation shaft of the second support member is a second axis that passes through the center of the imaging element and is parallel to the first axis, and
a direction in which the execution unit rotates the first support member by the first rotation unit is in an opposite direction to a direction in which the execution unit rotates the second support member by the second rotation unit, and an angle by which the execution unit rotates the first support member by the first rotation unit is identical to an angle by which the execution unit rotates the second support member by the second rotation unit.

5. The imaging apparatus according to claim 4, wherein:
the first rotation unit includes a first drive source configured to be rotatable and a first transmission mechanism configured to transmit rotation of the first drive source to the first support member, and
the second rotation unit includes a second drive source configured to be rotatable and a second transmission mechanism configured to transmit rotation of the second drive source to the second support member.

6. The imaging apparatus according to claim 4, wherein:
the first rotation unit includes a first drive source configured to be rotatable and a first transmission mechanism configured to transmit rotation of the first drive source to the first support member, and
the second rotation unit includes a second transmission mechanism configured to transmit rotation of the first drive source to the second support member.

7. The imaging apparatus according to claim 2, wherein:
the first orientation changing unit is a first moving unit configured to move a position of the first support member,
the second orientation changing unit is a second moving unit configured to move a position of the second support member, and
the execution unit, based on the set distance information, moves the position of the first support member by the first moving unit, moves the position of the second support member by the second moving unit, and changes a position of the focus lens by the focus changing unit.

8. The imaging apparatus according to claim 7, wherein:
a moving direction of the first support member and a moving direction of the second support member are directions parallel to a plane including a straight line connecting a center of the light emitting element and a center of the imaging element and a first straight line that passes through a midpoint of the straight line and extends in a direction of a subject, and intersect the first straight line, and
a moving direction and a moving distance of the center of the light emitting element by the first moving unit have a linear symmetric relation with respect to the first straight line to the moving direction and the moving distance of the center of the imaging element by the second moving unit.

9. The imaging apparatus according to claim 1, further comprising a display unit configured to display an image captured by the imaging element.

10. The imaging apparatus according to claim 1, wherein the input unit is an operation unit through which a user can input the set distance information.

11. The imaging apparatus according to claim 2, further comprising a display unit configured to display an image captured by the imaging element.

12. The imaging apparatus according to claim 2, wherein the input unit is an operation unit through which a user can input the set distance information.

13. The imaging apparatus according to claim 2 further comprising a distance measurement unit configured to be capable of measuring a distance to a subject,
wherein the execution unit executes the change of an orientation of the first support member by the first orientation changing unit, the change of an orientation of the second support member by the second orientation changing unit, and the change of a position of the focus lens by the focus changing unit, based on a measurement result of the distance measurement unit and the set distance information.

14. A control method of an imaging apparatus,
wherein the imaging apparatus comprises:
a light emitting element configured to irradiate a subject with a terahertz wave;
an imaging element configured to detect a terahertz wave reflected by a subject;
an image forming optical system configured to include a focus lens and form an image of a terahertz wave reflected by a subject on the imaging element;
a support member that supports the light emitting element;
a housing that supports the support member;
an orientation changing unit configured to change an orientation of the support member with respect to the housing;
a focus changing unit configured to be provided in the image forming optical system and perform change of a position of the focus lens; and
an input unit configured to receive set distance information that is a set value of a distance from the imaging element to a subject,
the control method comprising:
a step of inputting the set distance information to the input unit; and
a step of changing an orientation of the support member by the orientation changing unit and changing a position of the focus lens by the focus changing unit, based on the set distance information.
